(19) United States
(12) Patent Application Publication
(10) Pub. No.: US 2021/0037301 A1
(43) Pub. Date: Feb. 4, 2021

(54) EAR-WORN DEVICE

(71) Applicant: HUMAN, INCORPORATED, Seattle, WA (US)

(72) Inventors: Stephen John MINARSCH, Seattle, WA (US); Lea MARTIN, Seattle, WA (US); Adam Abraham JOSSEM, Seattle, WA (US); Dae Il KWON, Seattle, WA (US); Francesca Alyssum QUAGLIA, Seattle, WA (US); Benjamin S. WILLIS, Bellevue, WA (US); Joseph B. MOAK, San Carlos, CA (US); Sam Rhea SARCIA, Lakeside, CA (US); Donovan DEAME, San Francisco, CA (US); Douglas B. SATZGER, Menlo Park, CA (US)

(73) Assignee: Human, Incorporated, Seattle, WA (US)

(21) Appl. No.: 16/645,337

(22) PCT Filed: Sep. 7, 2018
(86) PCT No.: PCT/US2018/050110

§ 371 Date: Mar. 6, 2020

Related U.S. Application Data
(60) Provisional application No. 62/556,385, filed on Sep. 9, 2017.

(51) Int. Cl. H04R 1/02; H04R 1/10

(52) U.S. Cl. CPC H04R 1/02; H04R 1/1008; H04R 2420/07; H04R 1/1025; H04R 1/1066

(57) ABSTRACT

Various embodiments provide for an improved ear-worn device for attaching the ear-worn device to an ear of a user using a hooking body. The hooking body may be secured to the user's ear. In some embodiments, a device body may be coupled to the hooking body via a hinge. The device body may be moved (relative to the hooking body) using the hinge to cause the ear-worn device to transition from a closed configuration to an open configuration, and vice versa.

### RELATED APPLICATIONS

This application claims the benefit of priority to U.S. Provisional Application No. 62/556,385 entitled “ATTACHMENT APPARATUS,” filed on Sep. 9, 2017, the entire contents of the foregoing hereby incorporated by reference.

### BACKGROUND

Users of wearable audio systems—such as headphones and earphones—can choose between several different styles. However, current wearable audio systems typically utilize one of only a few common attachment mechanisms to secure these systems to the user. For example, one type of wearable audio system can be attached to a user's head via a headband that maintains the position of speakers on either side of the user's head. Another type of wearable audio system can be attached to the user by inserting the system into the user's ear canal. Current attachment mechanisms, including those described above, are often uncomfortable to wear, provide a suboptimal listening experience, or both. As such, developing an attachment mechanism that achieves a strong attachment to a user and that improves the user's comfort and overall listening experience continues to be a design and technical challenge.

### BRIEF DESCRIPTION OF THE DRAWINGS

The foregoing embodiments and many of the attendant advantages will become more readily appreciated as the same become better understood by reference to the following detailed description, when taken in conjunction with the accompanying drawings, wherein:

FIGS. 1A-1H are exterior views of an ear-worn device, according to some embodiments.

FIGS. 2A-2E are exterior views of an ear-worn device secured to a user's ear, according to some embodiments.

FIG. 3 is a communication system diagram illustrating an ear-worn device configured as a wearable audio system, according to some embodiments.

### DETAILED DESCRIPTION

Various embodiments of the ear-worn device may be described with reference to certain anatomical features of a human user's ear. For ease of reference, the anatomical features of a user's ear may be referred to in this disclosure using the following terms. The term “root of an ear” refers to a portion of the ear that is proximal to the user's head. Specifically, the root of a user's ear may be a portion or structure of the ear that secures the ear to the user's head. Also, as used herein, the term “outer ear” refers to the portion of the ear that is distal to the user's head as compared to the root of the ear. The outer ear may include or otherwise be defined by at least a portion of the ear's auricle, helix, and/or lobule. Typically, the perimeter of the outer ear of an ear is greater than the perimeter of the root of the ear. The term “upper portion of the ear” generally refers to a portion of the ear that is proximal to the top of the user's head. In contrast, the term “lower portion of the ear” refers to a portion of the ear that is distal to the top of the user's head. Further, the terms “front of an ear” and “anterior portion of an ear” are used interchangeably and refer to a portion of the ear that is proximal to a user's face and distal to the back of the user's head. The front of the ear may include portions of the helix, the antihelix, tragus, and antitragus that are proximal to the user's face. The terms “back of an ear” and “posterior portion of an ear” are used interchangeably and refer to a portion of the outer ear that is proximal to the back of the user's head and distal to the user's face. The back of the ear may include portions of the helix and the antihelix proximal to the back of the user's head. The term “interior portion of an ear” refers to a portion of the outer ear proximal to, but not including, the ear canal. The interior portion of an ear may include, without limitation, at least part of one or more of the concha, anti-helix, anti-tragus, and tragus. Further descriptions and references to the foregoing terms are provided herein.

As generally described above, current attachment mechanisms used to secure wearable audio systems to users are often suboptimal. For example, some wearable audio systems implement a type of attachment mechanism commonly referred to as an “over-the-ear” design. A wearable audio system utilizing an over-the-ear design is worn by a user by placing ear cups of the wearable audio system over and around the ears of the user. The ear cups are coupled to a headband positioned on the top or to the back of the user's head. The headband applies a compressive force to the user's head to secure the ear cups to the user, often resulting in headaches or general discomfort over time. This pressure is especially noticeable in some over-the-ear wearable audio systems that apply a substantial amount of pressure on the user to ensure that an acoustic seal is formed around the ear cups.

Other suboptimal wearable audio systems are also generally available. For example, some wearable audio systems are secured to users via insertion into users' ear canals. Often, such wearable audio systems cause users to experience discomfort over time by exerting a constant pressure against the ear canal walls. Further, while these systems can acoustically isolate the inner ear from external sounds, the seal is formed inside the ear canal, leading to an increased risk that audio played from such systems and directed into the ear canal will cause users to suffer hearing damage.

In overview, aspects of the present disclosure include ear-worn devices that include attachment mechanisms that feature improvements over current attachment mechanisms, such as those described above. Specifically, according to various embodiments described herein, such ear-worn devices may enable users to secure the ear-worn devices to the users' ears more easily than currently available attachment mechanisms. Additionally (or alternatively), users may wear such ear-worn devices with less discomfort than currently available attachment mechanisms.

In some embodiments, the ear-worn device may include a device body that is coupled to a hooking body. The device body may optionally include a mid-ear portion that may be suitable for mounting other components (e.g., a speaker system). The device body may include one or more facets configured to enable various components (e.g., batteries, printed circuit boards, etc.) to be mounted to the device body.

In some embodiments, the hooking body may secure the ear-worn device to at least a root of the upper portion of the user's ear and a root of a posterior portion of the user's ear. The hooking body may be coupled to the device body via a joint (e.g., a hinge or the like) that limits the range of movement of the device body in relation to the hooking body. As used herein, the term “joint” may generally refer to a mechanism or device that couples the device body to the hooking body and that enables the device body to move (e.g., pivot, rotate) in a direction towards and a direction away from engagement with the hooking body. For example, a joint may include a pin hinge, a ball-and-socket joint, a tension hinge, other mechanical hinge, or one of various other types of devices configured to movably couple the hooking body and the device body together and configured to limit the movement of the device body in relation to the hooking body.

The joint may be configured to enable the ear-worn device to transition between an open configuration and a closed configuration. In some embodiments, the ear-worn device may be in an “open configuration” when the device body is positioned away from engagement with the hooking body, such as when the device body is rotated or otherwise positioned away from the hooking body or, in some instances, biased away from engagement with the hooking body. For example, the device body may receive a force that causes the device body to swing away from the hooking body about the joint or that or that causes the device body to remain positioned away from the hooking body (e.g., by a spring or other biasing member). In some embodiments, the ear-worn device may be in a “closed” configuration when the device body and the hooking body are physically engaged. In some instances, a biasing member (e.g., torsional spring) may be provided to urge the ear-worn device into a closed configuration and one or more locking features may be provided to hold the ear-worn device in the closed configuration (e.g., magnetic attraction between magnetic element(s) included in the hooking body and the device body). In such embodiments, a user may be required to overcome the force of the biasing member to transition the ear-worn device from a closed configuration to an open configuration. When the ear-worn device is secured to the ear of the user, the hooking body and the device body may collectively apply a compressive force on at least the posterior portion of the user's ear (e.g., as further described herein). For ease of description, the ear-worn device, while secured to the user's ear, may be in a “partially closed configuration” when the device body and the hooking body engage the user's ear because the user's ear may prevent (at least partially) the device body from physically contacting the hooking body.

In some embodiments, each of the hooking body and the device body may include one or more coupling devices. In such embodiments, one or more first coupling devices of the device body may be configured to engage one or more second coupling devices of the hooking body to fasten or otherwise secure the device body to the hooking body. Accordingly, in some embodiments, the ear-worn device may be deemed to be in a closed configuration when the one or more first coupling devices engage the one or more second coupling devices, and the ear-worn device may be deemed to be in an open configuration when the one or more first coupling devices are released from or are not otherwise engaged with the one or more second coupling devices.

According to some embodiments, the ear-worn device for an example left ear device may be secured to the ear of the user by configuring the ear-worn device in an open configuration, hooking the hooking body to the upper root portion of the user's ear, and rotating the hooking body clockwise until a portion of the hooking body engages the posterior root portion of the user's ear. Once the portion of the hooking body engages the posterior root portion of the user's ear, the hooking body may not be able to continue rotating clockwise around the user's ear. The ear-worn device may be transitioned to a partially closed configuration by moving (e.g., swinging) the device body towards engagement with the hooking body until the device body fastens to or otherwise engages the hooking body. The ear-worn device may be unsecured and removed from the user's ear by performing the inverse of the above steps. Specifically, the ear-worn device may be transitioned from a partially closed configuration to an open configuration by unfastening or disengaging the device body from the hooking body and moving (e.g., swinging) the device body away from engagement with the hooking body. The ear-worn device may then be removed from the user's ear in part by rotating the hooking body counterclockwise to disengage the hooking body from the user's ear.

In some embodiments, the ear-worn device may be configured as a wearable audio system. In such embodiments, the device body may include one or more audio components. By way of non-limiting examples, the audio components may include a speaker system, memory, a processing unit (e.g., a digital signal processor or central processing unit), a transceiver configured to receive audio data from external computing devices, or the like. In some embodiments, while the ear-worn device is secured to a user's ear, a speaker system coupled to the device body may be positioned in proximity to an interior portion of the user's ear.

As used herein, references to an anterior side of an ear-worn device (or subpart or portion of that ear-worn device, including, for example, a hooking body or device body) refers to a side, surface, portion, or part of the ear-worn device that is facing or nearby a user's face while the user is wearing the ear-worn device. Similarly, references to a posterior side of an ear-worn device (or subunit or portion of that ear-worn device, including, for example, a hooking body or device body) refers to a side, surface, portion, or part of the ear-worn device that is facing or nearby a back of a user's head while the user is wearing the ear-worn device.

Various embodiments will be described in detail with reference to the accompanying drawings. Wherever possible, the same reference numbers will be used throughout the drawings to refer to the same or like parts. References made to examples and implementations are for illustrative purposes and are not intended to limit the scope of the invention or the claims.

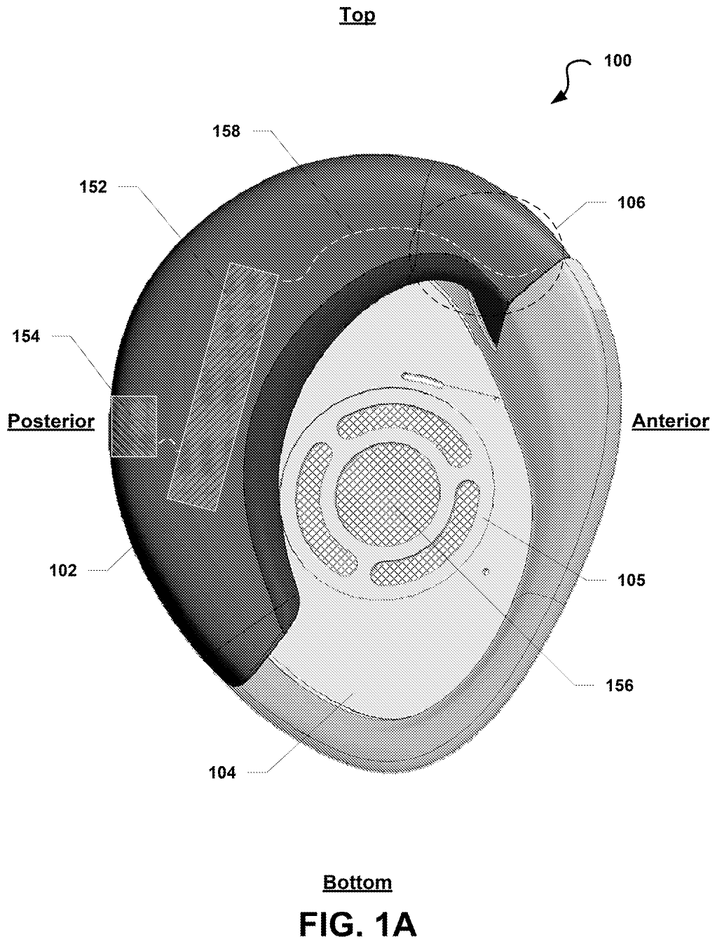

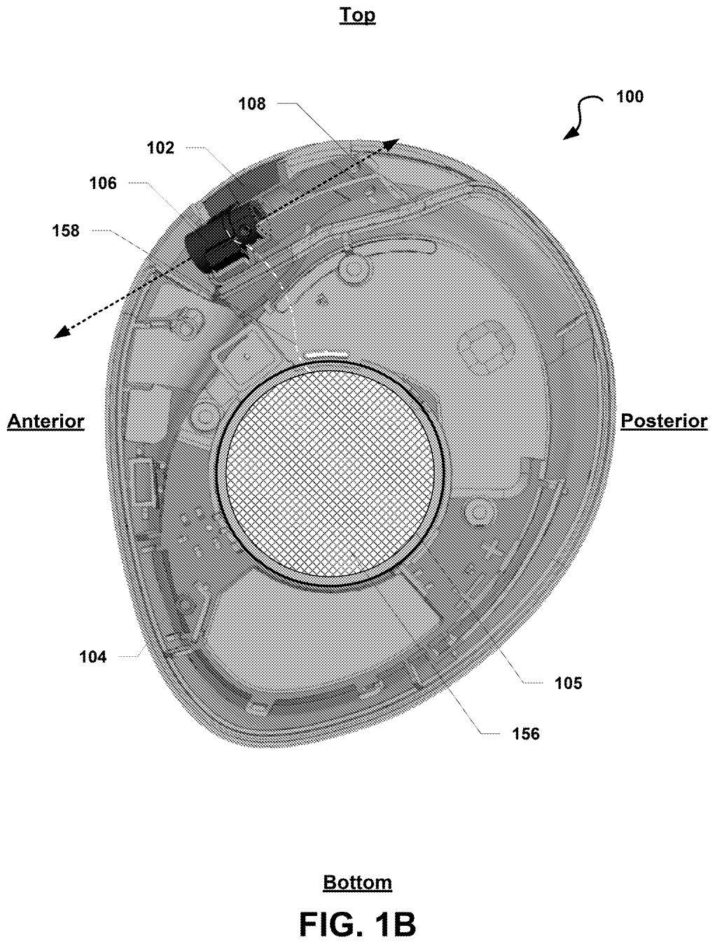

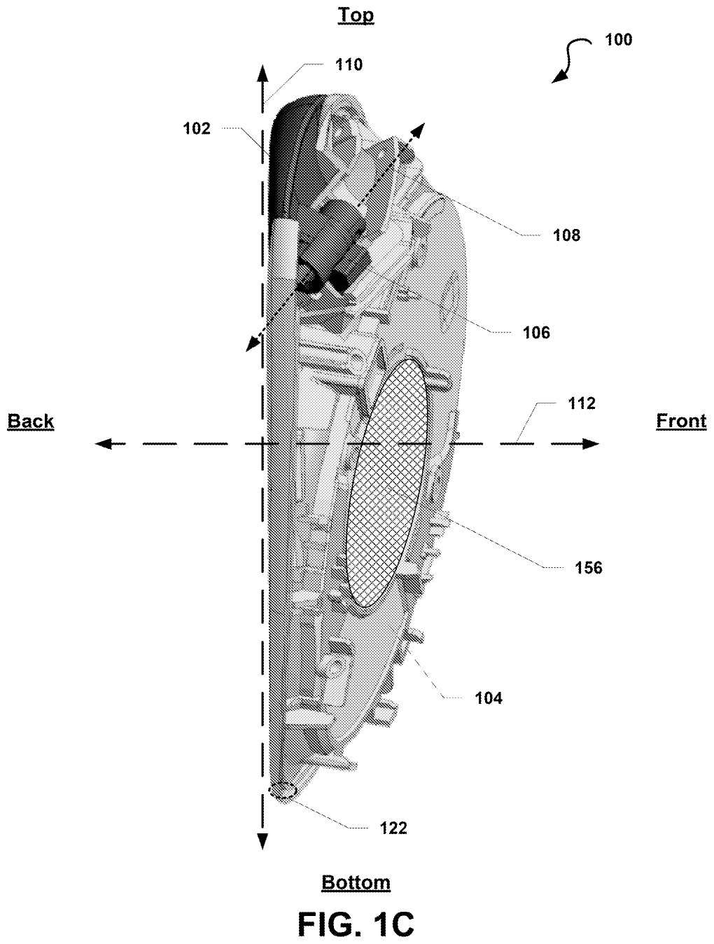

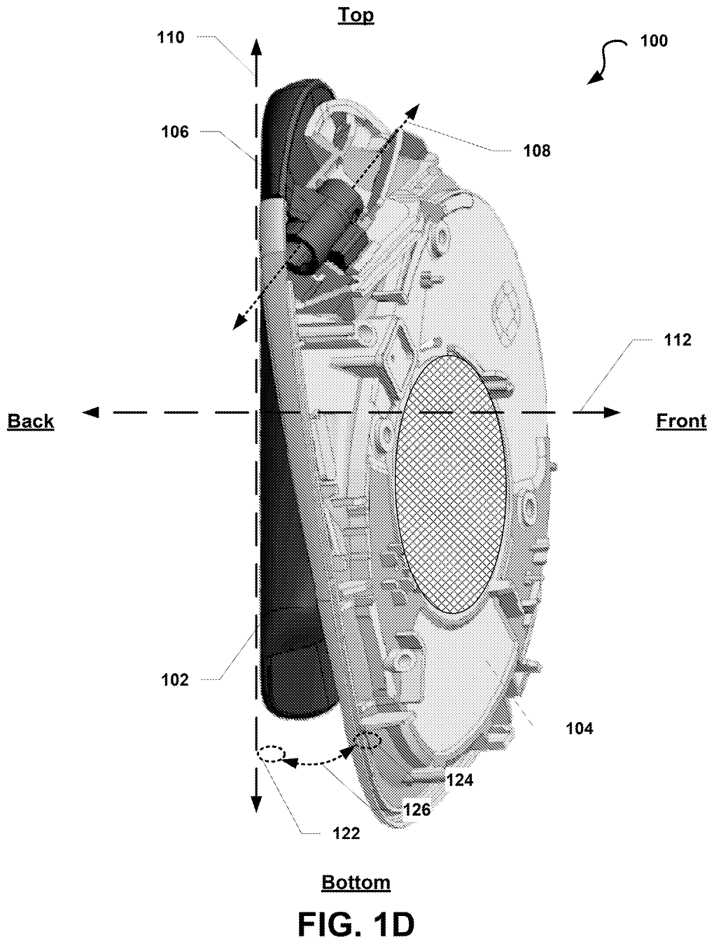

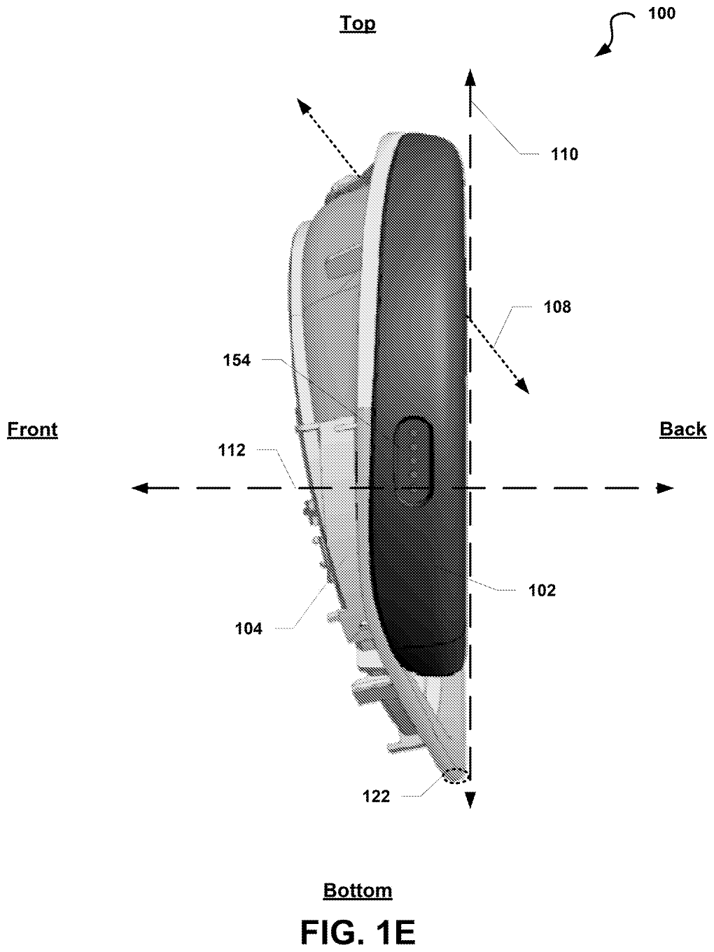

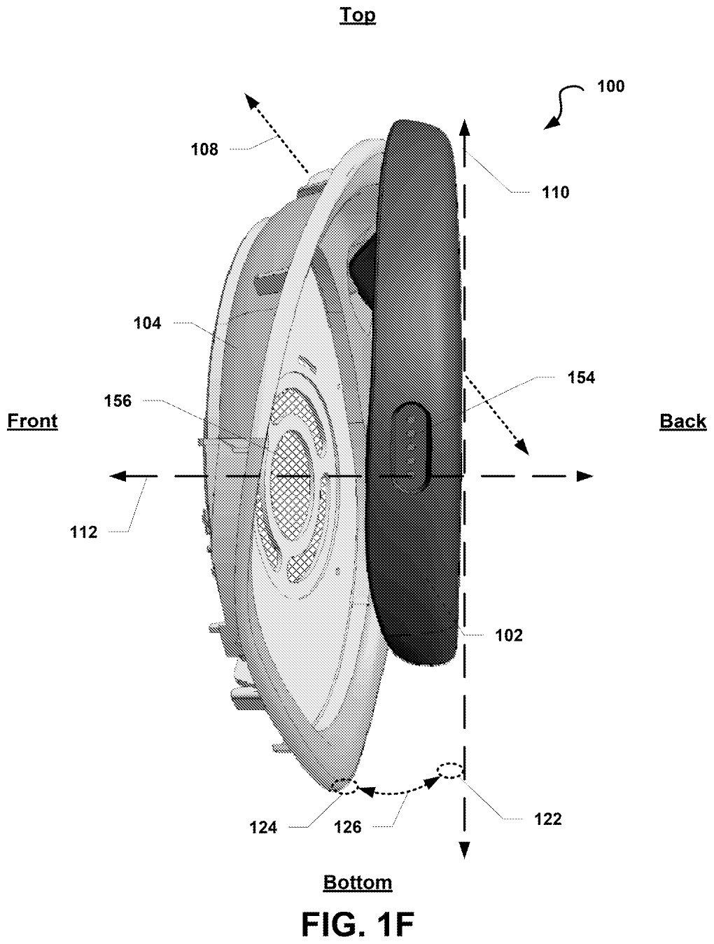

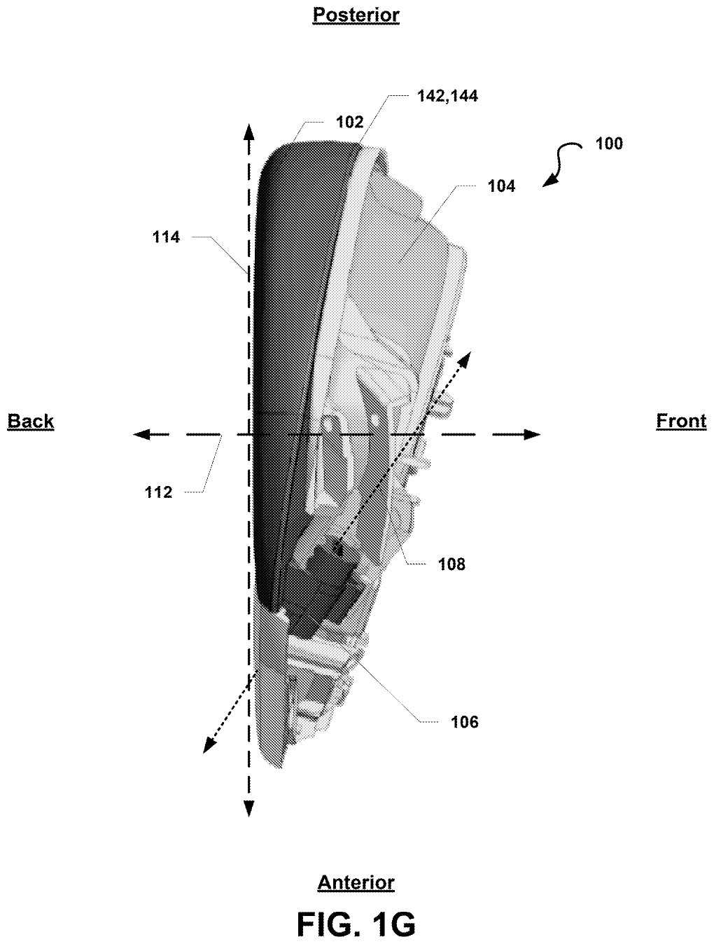

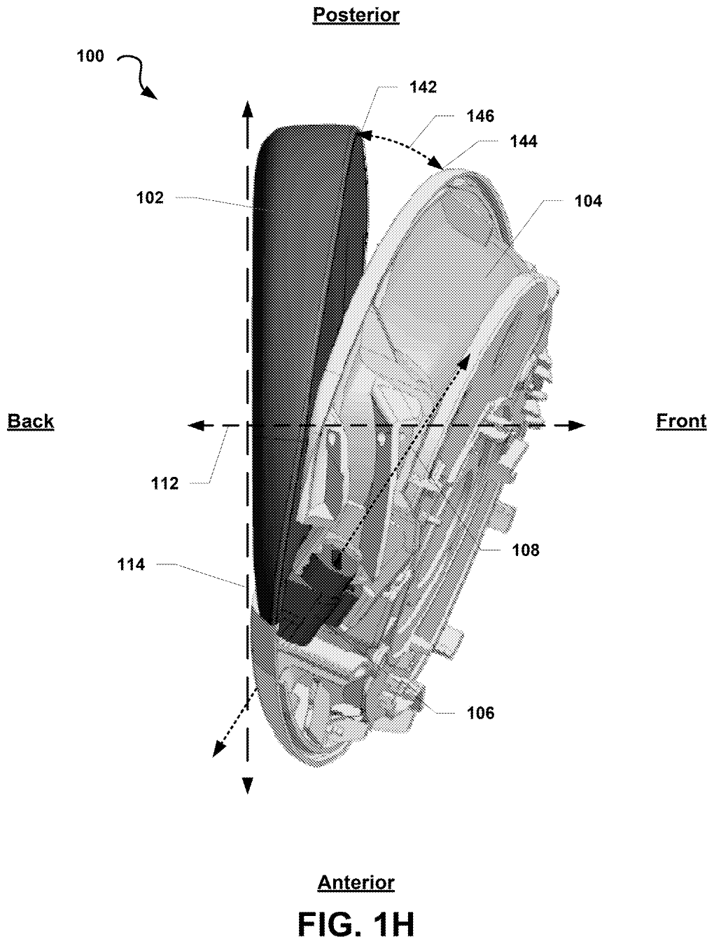

FIGS. 1A-1H illustrate exterior views of an ear-worn device 100, according to some embodiments. FIG. 1A illustrates an exterior view of a back of the ear-worn device 100 while the ear-worn device 100 is configured in a closed configuration. FIG. 1B illustrates an exterior view of a front side of the ear-worn device 100 while the ear-worn device 100 is configured in a closed configuration. FIG. 1C illustrates an exterior view of an anterior side of the ear-worn device 100 while the ear-worn device 100 is configured in a closed configuration. FIG. 1D illustrates an exterior view of an anterior side of the ear-worn device 100 while the ear-worn device 100 is configured in an open configuration. FIG. 1E illustrates an exterior view of a posterior side of the ear-worn device 100 while the ear-worn device 100 is configured in a closed configuration. FIG. 1F illustrates an exterior view of a posterior side of the ear-worn device 100 while the ear-worn device 100 is configured in an open configuration. FIG. 1G illustrates an exterior view of a top side of the ear-worn device 100 while the ear-worn device 100 is configured in a closed configuration. FIG. 1H illustrates an exterior view of a top side of the ear-worn device 100 while the ear-worn device 100 is configured in an open configuration.

As generally described with reference to the examples illustrated in FIGS. 1A-1H, the ear-worn device 100 may include a plurality of structural features, including without limitation, a hooking body 102 and a device body 104. The hooking body 102 of the ear-worn device 100 may be configured to have a shape that approximates a profile of a root of a posterior portion of a human ear. This shape may be referred to generally as a C-shape. When the hooking body 102 is secured to the user's ear, the hooking body 102 may be positioned proximal to and/or may engage a surface of a root of the back and/or top portion of the user's ear. The device body 104 may be configured to have a shape that approximates the profile of a human's outer ear, and as such, the device body 104 may be elliptical or roughly elliptical in shape. In some embodiments, the device body 104 may include or define a mid-ear portion 105 that is substantially positioned at a center or approximate center of the device body 104. In some embodiments, the mid-ear portion 105 may be configured to be suitable for receiving, coupling to, or otherwise accommodating a speaker system that may be mounted to the mid-ear portion 105. For example, the mid-ear portion 105 may include one or more fasteners or mounting systems (not shown) that may be configured to couple to corresponding fasteners or mounting systems on a speaker system. In some embodiments, the mid-ear portion 105 may define an opening in the device body 104 that has a shape suitable for receiving or otherwise accommodating at least a portion of a speaker system. While the opening defined by the mid-ear portion 105 is illustrated in various corresponding drawings as having a substantially circular shape, in some embodiments, the mid-ear portion 105 may be configured to define an opening having one of various shapes, including but not limited to, circular, rectangular, elliptical, or various other shapes.

In some embodiments, the hooking body 102 may include one or more electrical components. For example, with reference to FIG. 1A, the hooking body 102 may include a battery 152 and a power charging connector 154. In some embodiments, the battery 152 may, via one or more electrical leads 158, provide power to the speaker system 156 included in or attached to the device body 104 and/or to various other electrical components of the ear-worn device 100 (not shown).

The ear-worn device 100 may include a hinge 106. In some embodiments, the device body 104 may be coupled to the hooking body 102 via the hinge 106. For example, the hinge 106 may be one of various types of hinges (e.g., a tension hinge). The hinge 106 may be configured to couple the device body 104 to the hooking body 102 so that movement of one of the device body 104 or the hooking body 102 is limited in relation to each other. In some embodiments (not shown), the hooking body 102 and the device body 104 may each include complementary magnetic elements that maintain the hooking body 102 and the device body 104 in the closed configured. As such, as the device body 104 is moved towards the hooking body 102, the complementary magnetic elements may pull towards each other, thereby urging the device body 104 towards the hooking body 102.

The hinge 106 may be formed from one or more portions of the hooking body 102 and the device body 104. In some embodiments, the hinge 106 may additionally include one or more other structural features. In a non-limiting example, the hinge 106 may be formed at least in part by a portion of the hooking body 102, a portion of the device body 104, and a biasing member (e.g., a torsion spring). In some alternative (or additional) embodiments, the hinge 106 may be a separate structural feature that is separately coupled to the hooking body 102 and the device body 104. In a non-limiting example, the hinge 106 may include a housing configured to couple to a portion of the hooking body 102 and a portion of the device body 104 such that, while the hooking body 102 and the device body 104 are coupled to the hinge 106, the hinge 106 governs the movement of the hooking body 102 and the device body 104 in relation to one another.

With reference to FIGS. 1C-1H, the hinge 106 may be configured to enable the device body 104 to be moved (e.g., swung, rotated, or pivoted) away from the hooking body 102 to cause the ear-worn device 100 to transition from a closed configuration (e.g., as illustrated in FIGS. 1C, 1E, and 1G) to an open configuration (e.g., as illustrated in FIGS. 1D, 1F, and, 1H) by rotating about a rotational axis 108. The hinge 106 may also be configured to enable the device body 104 to be moved (e.g., swung, rotated, or pivoted) back towards the hooking body 102, for example, to transition the ear-worn device 100 from an open configuration to a closed configuration by rotating in the opposite direction along the rotational axis 108.

The hinge 106 may be coupled to the hooking body 102 and the device body 106 so that the rotational axis 108 of the hinge 106 is offset from the hooking body 102 and the device body 106. Rotating the device body 104 about the hinge 106 may cause the device body 104 to change position in three dimensions relative to the hooking body 102. In the examples illustrated in FIGS. 1C-1H, a first dimension is represented by a first directional axis 110, a second dimension is represented by a second directional axis 112, and a third direction is represented by a third directional axis 114.

FIGS. 1C and 1E illustrate different perspectives of the ear-worn device 100 in which the ear-worn device 100 is configured in a closed configuration, according to some embodiments. Specifically, a portion of the device body 104 may be positioned at a first position 122 while the ear-worn device 100 is configured in a closed configuration. By rotating the device body 104 along the rotational axis 108 of the hinge 106, that portion of the device body 104 may change position relative to the hooking body 102 along each of the first directional axis 110, the second directional axis 112, and the third directional axis 114. As such, as illustrated in FIGS. 1D and 1F, the portion of the device body 104 may transition from the first position 122 to a second position 124 by rotating along the rotational axis 108 along a path (e.g., as represented by dotted reference line 126). In these illustrated examples, the first position 122 of the device body 104 may differ from the second position 124 of the device body 104 in three dimensions illustrated by the first, second, and third directional axes 110, 112, 114. For example, as determined in relation to the hooking body 102, a three-dimensional coordinate (e.g., an (x, y, z) coordinate) of the portion of the device body 104 at the first position 122 may differ from a three-dimensional coordinate of the portion of the device body 104 at the second position 124 in each of the three coordinate values. In some embodiments, the position of the device body 104 may only change in two dimensions relative to the hinge 106.

In some embodiments, a degree of change experienced (e.g., a linear distance moved, degrees rotated, and the like) by a portion of the device body 104 when transitioning between a first position and a second position may depend at least in part on a proximity to the hinge 106. When the ear-worn device 100 transitions from a closed configuration to an open configuration, a first portion of the device body 104 farther from the hinge 106 than a second portion of the device body 104 may move to a greater extent in at least one dimension than the extent to which the second portion of the device body 104 moves in the at least one dimension.

In some embodiments, the hinge 106 may be configured to limit the extent to which the device body 104 and the hooking body 102 may be moved toward and away from each other. In the example illustrated in FIG. 1D, the position of the device body 104 relative to the hooking body 102 may depict the furthest extent to which the device body 104 may be moved away from the hooking body 102. Accordingly, in this example, the ear-worn device 100 may be in a “fully open” configuration because the hinge 106 is preventing the device body 104 from being moved further away from the hooking body 102.

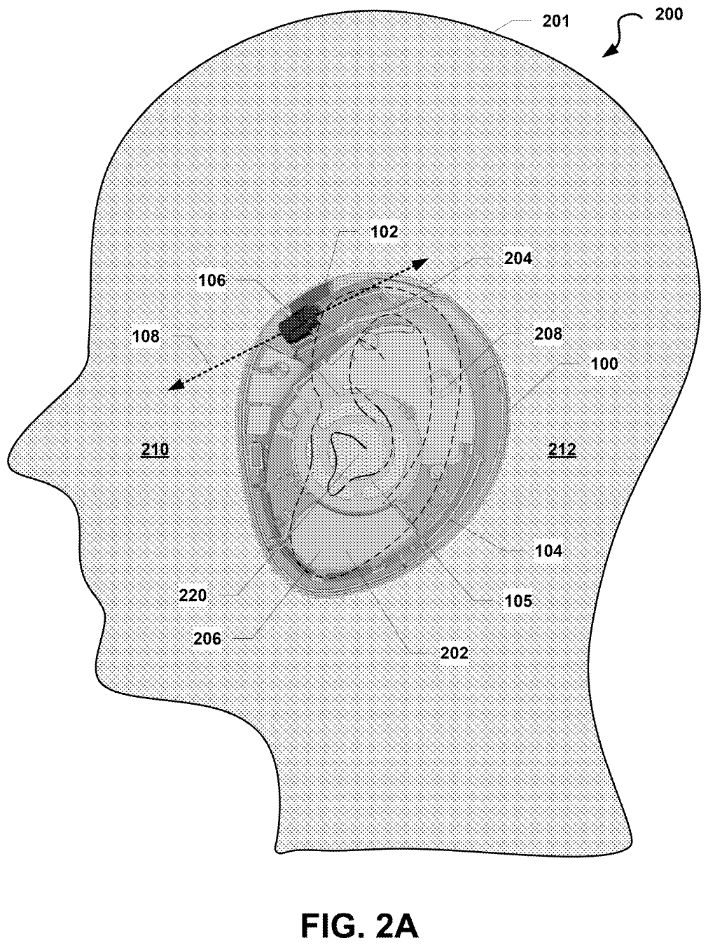

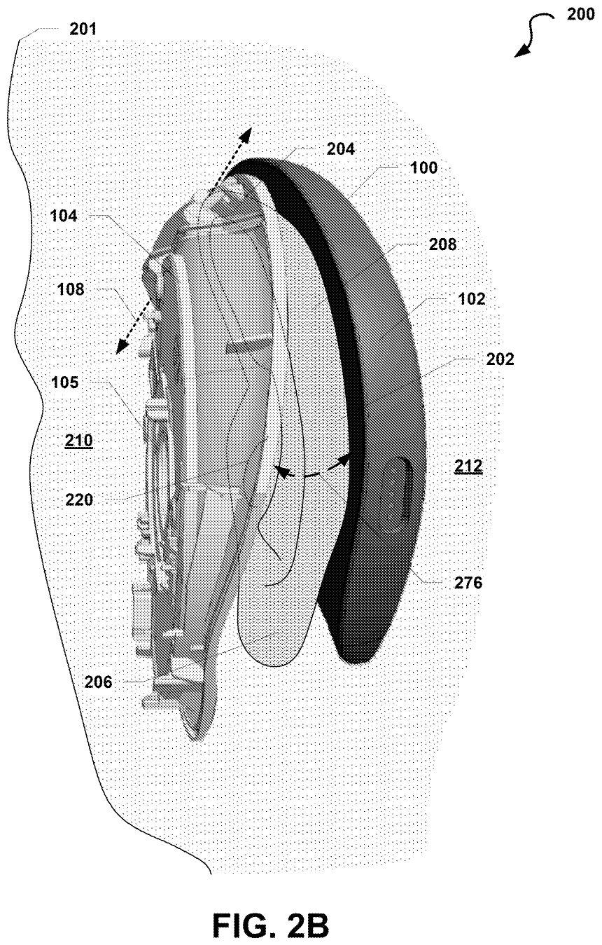

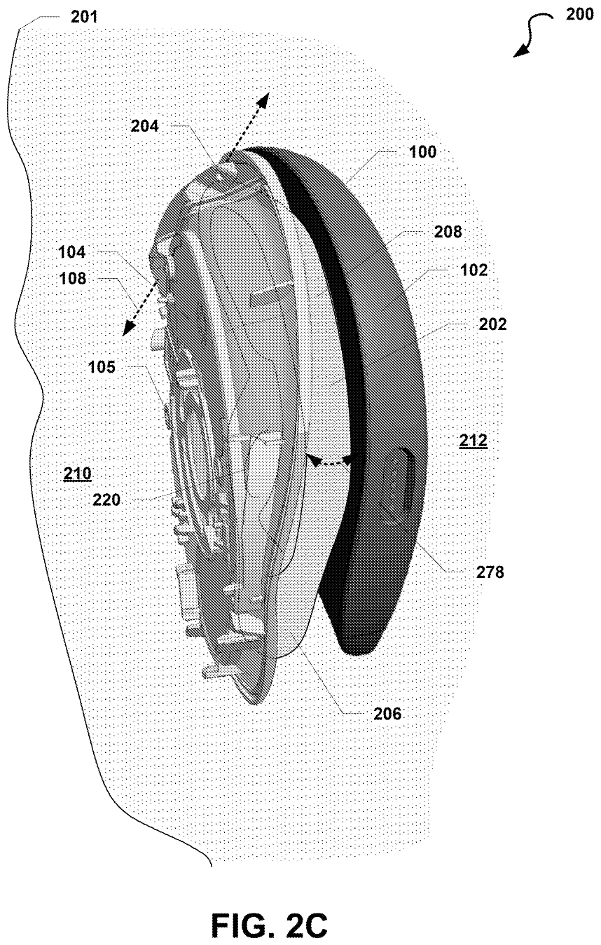

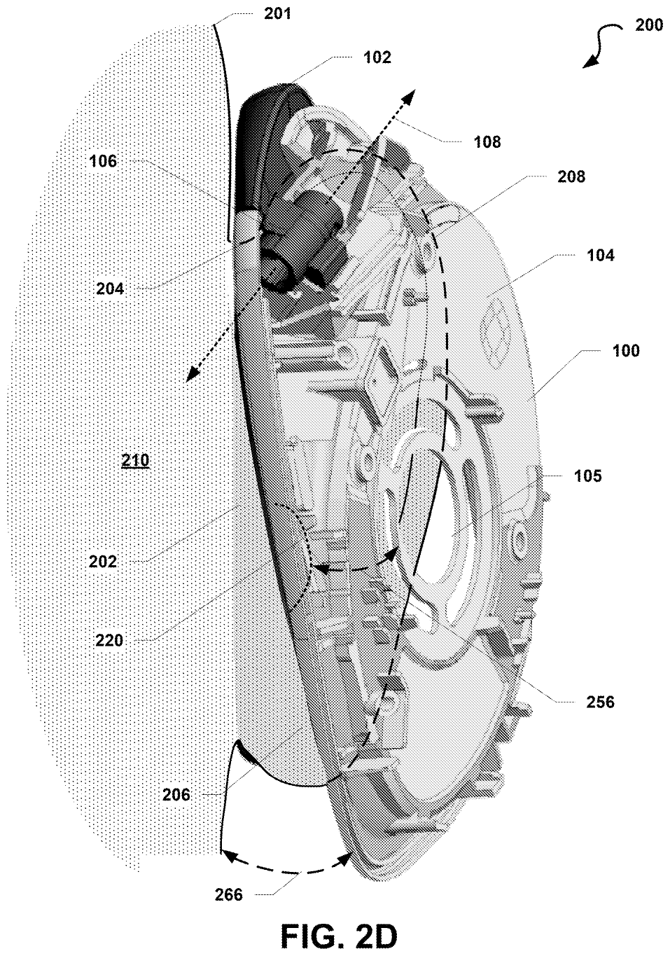

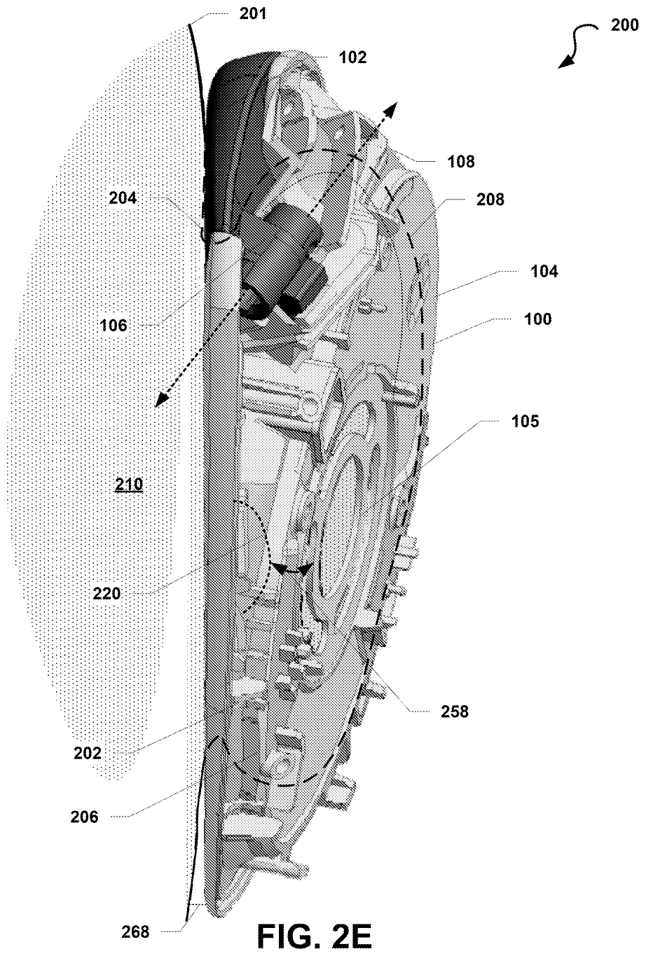

In some embodiments, while the ear-worn device 100 is configured in a closed configuration, a distance between a surface of the device body 104 facing a back side of the ear-worn device 100 may physically contact or may be near a surface of the hooking body 102 facing a front side of the ear-worn device 102. As the ear-worn device 102 transitions from a closed configuration to an open configuration, a distance between the surface of the device body 104 and the surface of the hooking body 102 may increase so that a space or gap forms between at least a portion of the hooking body 102 and at least a portion of the device body 104. In the example illustrated in FIG. 1G in which the ear-worn device 100 is configured in a closed configuration, a point 142 on a surface of the hooking body 102 may be physically in contact with a point 144 on a surface of the device body 104. However, in the example illustrated in FIG. 1G in which the ear-worn device 100 is configured in an open configuration, the point 142 on a surface of the hooking body 102 may be separated from the point 144 on a surface of the device body 104 (e.g., as indicated by reference line 146). In some embodiments, the gap or space formed between the hooking body 102 and the device body 104 may be suitable for receiving at least a portion of a human ear (e.g., as further described with reference to FIGS. 2A-2E).

In various embodiments described herein, the ear-worn device 100 may be described as transitioning from a closed configuration to an open configuration. However, the ear-worn device 100 may, in some additional or alternative embodiments, may be configured to transition from an open configuration to a closed configuration in a manner opposite of the manner described above with reference to transitioning from a closed configuration to an open configuration.

FIGS. 2A-2E illustrate exterior views of an environment 200 in which an ear-worn device (e.g., the ear-worn device 100 described with reference to FIGS. 1A-1H) is secured to an outer ear 202 of a user 201, according to some embodiments. Specifically, FIG. 2A illustrates an exterior view of a front side of the ear-worn device 100 while the ear-worn device 100 is secured to the outer ear 202 of the user 201, according to some embodiments. FIG. 2B illustrates an exterior perspective view of a posterior side of the ear-worn device 100 while the ear-worn device 100 is worn on the outer ear 202 and configured in an open configuration. FIG. 2C illustrates an exterior perspective view of a posterior side of the ear-worn device 100 while the ear-worn device 100 is secured to the outer ear 202 and configured in a partially closed configuration. FIG. 2D illustrates an exterior view of an anterior side of the ear-worn device 100 while the ear-worn device 100 is worn on the outer ear 202 and configured in an open configuration. FIG. 2E illustrates an exterior view of an anterior side of the ear-worn device 100 while the ear-worn device 100 is secured to the outer ear 202 and configured in a partially closed configuration.

With reference to the example illustrated in FIG. 2A, the ear-worn device 100 may be secured to the outer ear 202 of a user 201, which outer ear 202 may include a posterior portion 208, an upper portion 204, an interior portion 220, and a lower portion 206. While the ear-worn device 100 is secured to the outer ear 202, an anterior side of the ear-worn device 100 may face an anterior side 210 of the user 201, and a posterior side of the ear-worn device 100 may face a posterior side 212 of the user 201. In some embodiments, the device body 104 may cover all or substantially all of the user's outer ear 202. Accordingly, when viewed from a front side of the ear-worn device 100, the device body 104 may completely (or substantially) obscure the outer ear 202 when the ear-worn device 100 is secured to the outer ear 202.

The hooking body 102 and the device body 104 of the ear-worn device 100 may be configured collectively so that the ear-worn device 100 may be worn on and secured to the outer ear 202. The ear-worn device 100 may be configured in an open configuration (e.g., by moving the hooking body 102 away from the device body 104 via the hinge 106) so that a space or gap (e.g., a gap 276, FIG. 2B) is present between the hooking body 102 and the device body 104 (e.g., as described with reference to FIGS. 1G-1H). The ear-worn device 100 may then be placed on the outer ear 202 by hooking, hanging, or otherwise positioning the hooking body 102 along the root of the upper portion 204 of the outer ear 202 and by rotating the hooking body 102 until the hooking body 102 engages the root of the posterior portion 208 of the outer ear 202 (obscured by the hooking body 102 in the examples illustrated in FIGS. 2B-2C). Because the ear-worn device 100 features a space or gap between the hooking body 102 and the device body 104 while the ear-worn device 100 is in an open configuration, the posterior portion 208 of the outer ear 202 may move into, at least partially, in such space or gap and remain in such space or gap once the hooking body 102 engages the root of the posterior portion 208 of the outer ear 202 (e.g., as shown in the example illustrated in FIG. 2B). In a non-limiting example (e.g., as illustrated in FIG. 2B), the device body 104 and the rotational axis 108 of the hinge 106 may be configured so that the device body 104 is positioned upward and away from the outer ear 202 while in the ear-worn device 100 is configured in an open configuration. In some further embodiments, padding or other comfortable material may be attached to a surface of the device body 104 that engages the interior portion 220 or another portion of the outer ear 202 to improve comfort while the ear-worn device 100 is secured to the outer ear 202.

While the hooking body 102 is hooked onto the outer ear 202 and while the ear-worn device 100 is configured in an open configuration, the device body 104 may be moved (e.g., swung) along the rotational axis 108 of the hinge towards the hooking body 102. As the device body 104 continues moving towards the hooking body 104, the space or gap between the hooking body 102 and the device body 104 may decrease in at least one dimension (compare, for example, the gap 276 illustrated in FIG. 2B with a gap 278 illustrated in FIG. 2C) until the device body 104 physically contacts at least the posterior portion 208 of the outer ear 202. In some embodiments, once the device body 104 contacts the posterior portion 208 of the outer ear 202, the device body 104 may begin pressing the posterior portion 208 against the hooking body 102, generating a compressive force that secures the posterior portion 208 of the outer ear 202 between the device body 104 and the hooking body 102. For ease of description, the ear-worn device 100 may be described herein as being configured in a partially closed configuration while the posterior portion 208 of the outer ear 202 is secured between the device body 104 and the hooking body 102.

When the device body 104 is moved (e.g., swung) so that the ear-worn device 100 transitions to the closed (or partially closed) position, the mid-ear portion 105 of the device body 104 may move into proximity of the interior portion 220 of the outer ear 202. In some embodiments in which a speaker system (not shown) is coupled to the mid-ear portion 105 of the device body 104, the rotational axis 108 of the hinge 106 and the configuration of the device body 104 may cause the speaker system to move nearer to the interior portion 220 of the outer ear 202, thereby enabling the user to experience the speaker system. In the example illustrated in FIG. 2D, the ear-worn device 100 may be configured in an open configuration such that the mid-ear portion 105 of the device body 104 is a first distance (represented by dotted line 256) from the interior portion 220 of the outer ear 202 while the ear-worn device 100 is worn on the outer ear 202. In the example illustrated in FIG. 2E, the ear-worn device 100 may be secured to the outer ear 202 in a partially closed configuration such that the mid-ear portion 105 of the device body 104 is a second distance (represented by dotted line 258) from the interior portion 220 of the outer ear 202. In these examples, the first distance may be greater than the second distance.

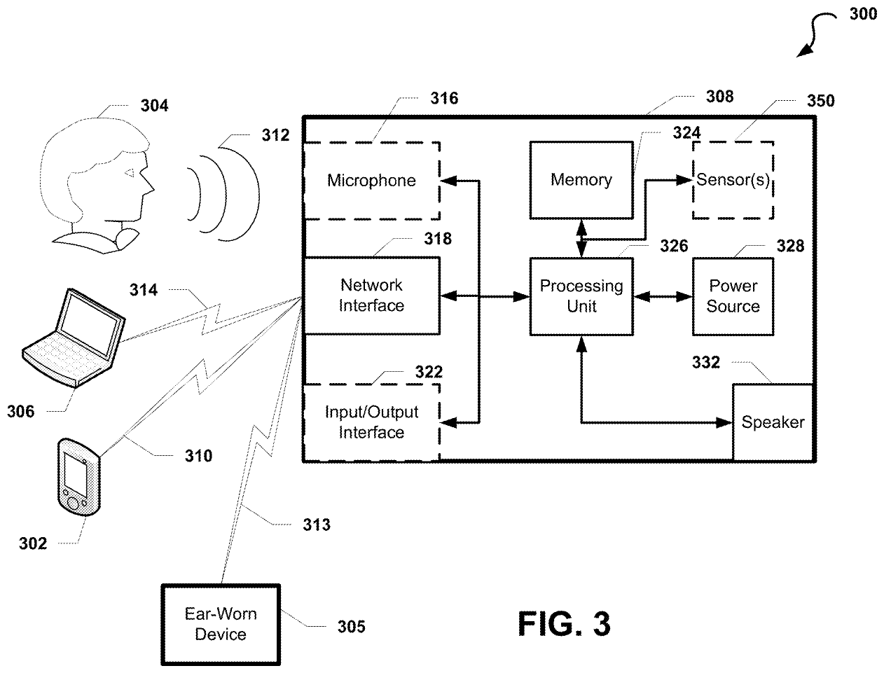

FIG. 3 is a functional block diagram of an illustrative operating environment 300 suitable for implementing aspects of the present disclosure. The operating environment 300 includes an ear-worn device 308 that may be configured to receive audio data from various sources, including a mobile computing device 302, an analog source of sound 304 (e.g., a human), or another computing device 306.

The example illustrated in FIG. 3 depicts a general architecture of the ear-worn device 308 that may be configured to playout audio, among other functions. The general architecture of the ear-worn device 308 includes an arrangement of computer hardware and/or software components. The ear-worn device 308 may include more (or fewer) elements than those shown in FIG. 3. It is not necessary, however, that all of these generally conventional elements be shown to provide an enabling disclosure. In some embodiments, the ear-worn device 308 may be configured as described above with reference to the ear-worn device 100 (e.g., described with reference to FIG. 1A-2E).

As illustrated, the ear-worn device 308 may include an input/output device interface 322, a network interface 318, an optional microphone 316, a memory 324, a processing unit 326, a power source 328, and a speaker 332, all of which may communicate with one another by way of a communication bus. The network interface 318 may provide connectivity to one or more networks or computing systems, and the processing unit 326 may receive and/or send information and instructions from/to other computing systems or services via the network interface 318. In some embodiments, the network interface 318 may be configured to communicate with the mobile computing device 302 and/or the other computing device 306 via wireless communication links 310 and 314, such as via a Wi-Fi Direct or Bluetooth communication links. The network interface 318 may also (or alternatively) be configured to communicate with the computing devices 302 and 306 via a wired communication link (not shown). Those skilled in the art will recognize that the computing devices 302 and 306 may be any of a number of computing devices capable of communicating via a wireless or wired link including, but not limited to, a laptop, personal computer, personal digital assistant (PDA), hybrid PDA/mobile phone, mobile phone, smartphone, wearable computing device (e.g., wireless headphones or earphones), electronic book reader, digital media player, tablet computer, gaming console or controller, kiosk, augmented or virtual reality device, other wireless device, set-top or other television box, or the like. In such embodiments, the network interface 318 may receive audio data from the mobile computing devices 302 and/or 306 and may provide the audio data to the processing unit 326. In such embodiments, the processing unit 326 may cause the audio data to be transformed into an electrical audio signal that is provided to the speaker 332 for output as sound. In some embodiments, the network interface 318 may provide connectivity to another ear-worn device 305, such as via a wireless communication link 313. In such embodiments, the other ear-worn device 305 may be configured as a mirror image of the ear-worn device 308.

The processing unit 326 may communicate to and from memory 324. In some embodiments, the memory 324 may include RAM, ROM, and/or other persistent, auxiliary or non-transitory computer-readable media. The memory 324 may store an operating system that provides computer program instructions for use by the processing unit 326 in the general administration and operation of the ear-worn device 308. In some embodiments, the memory 324 may contain digital representations of audio data or electronic audio signals (e.g., digital copies of songs or videos with audio). In such embodiments, the processing unit 326 may obtain the audio data or electronic audio signals from the memory 324 and may provide electronic audio signals to the speaker 332 for playout as sound.

In some embodiments, the input/output interface 322 may also receive input from an input device (not shown), such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or another input device known in the art. In some embodiments, the microphone 316 may be configured to receive sound 312 from an analog sound source 304. For example, the microphone 316 may be configured to receive human speech. The microphone 316 may further be configured to convert the sound into audio data or electrical audio signals that are directly or indirectly provided to the speaker 332 for output as sound.

Each of the communication links 310 and 314 may be communication paths through networks (not shown), which may include wired networks, wireless networks or combination thereof. In addition, such networks may be personal area networks, local area networks, wide area networks, cable networks, satellite networks, cellular telephone networks, etc. or combination thereof. In addition, the networks may be a personal area network, local area network, wide area network, over-the-air broadcast network (e.g., for radio or television), cable network, satellite network, cellular telephone network, or combination thereof. In some embodiments, the networks may be private or semi-private networks, such as a corporate or university intranets. The networks may also include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art and, thus, are not described in more detail herein.

In some embodiments, the ear-worn device 308 may include one or more sensors 350. The one or more sensors 350 may include, but are not limited to, one or more biometric sensors, heat sensors, gyroscopic sensors, accelerometers, pressure sensors, force sensors, light sensors, or the like. In such embodiment, the one or more sensors 350 may be configured to obtain sensor information from a user of the ear-worn device 308 and/or from an environment in which the ear-worn device 308 is worn by the user. The processing unit 326 may receive sensor readings from the one or more sensors 350 and may generate one or more outputs based on these sensor readings. For example, the processing unit 326 may configure a light-emitting diode included on the ear-worn device (not shown) to flash according to a preconfigured patterned based on the sensor readings.

Examples illustrated in the accompanying drawings may depict one or more embodiments of the ear-worn device as being configured for use with a left ear of a user. However, any descriptions or illustrations of the foregoing ear-worn devices that cause the ear-worn device to be suitable for use with a left ear of a user are made merely for ease of description. As such, unless otherwise limited by the claims, there is no requirement that the ear-worn devices described above must be configured for use only with left ears. For example, without loss of generality, any of the above ear-worn devices may be configured to couple to a right ear of a user by mirroring the structures described and illustrated above. Further, in some embodiments (not shown), any of the various ear-worn devices described above may be utilized with a mirrored ear-worn device that is configured to function on an opposite ear. In such embodiments, an ear-worn device and a mirrored ear-worn device may operate together as part of a single audio system because the ear-worn device may be configured for use with one ear of the user, and the mirrored ear-worn device may be coupled for use with the other ear (or vice versa). For example, in some embodiments in which the ear-worn device and the mirrored ear-worn device are configured as wearable audio systems, the user may utilize the ear-worn device and the mirrored ear-worn device together to experience stereophonic sounds in which an audio source is played simultaneously or nearly simultaneously through both the ear-worn device and the mirrored ear-worn device.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” unless specifically stated otherwise, is otherwise understood with the context as used in general to present that an item, term, etc., may be either X, Y, or Z, or any combination thereof (e.g., X, Y, and/or Z). Thus, such language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. An ear-worn device for coupling to an ear of a user, comprising:
a device body;
a hooking body; and
a hinge coupled to the device body and the hooking body;
wherein:
the hinge is configured such that a rotational axis of the hinge is askew from a three-dimensional orientation of the device body and a three-dimensional orientation of the hooking body;
relative to the hooking body, a first position of the device body while the ear-worn device is in a closed configuration differs from a second position of the device body while the ear-worn device is in an open configuration along three directional axes; and
relative to the hinge, the first position of the device body while the ear-worn device is in a closed configuration differs from the second position of the device body while the ear-worn device is in an open configuration along two directional axes.

2. The ear-worn device of claim 1, wherein the hinge comprises a torsion spring that biases the device body towards the hooking body.

3. The ear-worn device of claim 1, wherein the hooking body and the device body are collectively configured to apply a compressive force to a posterior portion of the ear when moving the ear-worn device from the open configuration toward the closed configuration.

4. The ear-worn device of claim 1, wherein transitioning the ear-worn device from the open configuration to the closed configuration while the ear-worn device is secured to the ear causes a mid-ear portion of the device body to move proximate to an interior portion of the ear.

5. The ear-worn device of claim 1, wherein the hooking body comprises a battery and a charging connector.

6. The ear-worn device of claim 5, wherein:
the device body comprises at least one electronic component; and
the ear-worn device comprises at least one electrical lead configured to supply power from the battery to the at least one electrical component.

7. The ear-worn device of claim 6, wherein the at least one electrical lead is configured to pass through the hinge.

8. The ear-worn device of claim 6, wherein the at least one electronic component is a speaker system.

9. An ear-worn device configured according to any of claims 1-8 and further configured as a personal listening device.

10. A system comprising an ear-worn device as claimed in any of claims 1-8.

11. A system comprising:
a first ear-worn device as claimed in any of claims 1-8;
a second ear-worn device configured as a mirror-image of the first ear-worn device.

12. The system of claim 11, wherein:
the first ear-worn device comprises a first coupling device;
the second ear-worn device comprises a second coupling device; and
the first coupling device and second coupling device are configured to couple selectively together.

13. A personal listening device, comprising:
a speaker;
a device body accommodating the speaker;
a hooking body configured to assist in attaching the device body to a user's ear; and
a hinge operably coupling the device body to the hooking body to enable the device body to move between an open configuration, in which a lower end of the device body is positioned relatively further away from a distal end of the hooking body to enable the user to position the user's ear between the device body and the hooking body or to withdraw the user's ear from between the device body and the hooking body, and a closed configuration, in which the lower end of the device body is positioned relatively closer to the distal end of the hooking body, and
wherein the hinge is configured such that, with the hooking body attached to the user's ear, the lower end of the device body moves simultaneously away from a median plane and a transverse plane of the user when moving from the closed configuration to the open configuration.

14. The personal listening device of claim 13, wherein the hooking body and the device body are collectively configured to apply a compressive force to a posterior portion of the ear when the device body moves from the open configuration toward the closed configuration.

15. The personal listening device of claim 13, wherein the hinge is configured such that, with the hooking body attached to the user's ear, the speaker is moved to a position proximate an interior portion of the user's ear when moving from the open configuration to the closed configuration.

16. The personal listening device of claim 13, wherein the speaker is powered by a power source located within the hooking body.

17. The personal listening device of claim 16, wherein the speaker is powered by the power source via an electrical lead passing through the hinge.

18. The personal listening device of claim 16, wherein the power source is a rechargeable battery and the hooking body includes a charging connector for charging the rechargeable battery.
